(19) United States
(12) Patent Application Publication
(10) Pub. No.: US 2017/0254497 A1
(43) Pub. Date: Sep. 7, 2017

(54) ADJUSTABLE HEADLIGHT DEVICE

(71) Applicant: NATIONAL CENTRAL UNIVERSITY, TAOYUAN COUNTY (TW)

(72) Inventors: WEN-HSIN SUN, TAOYUAN CITY (TW); WEI-CHEN LO, MIAOLI COUNTY (TW); YU-HAO CHAO, KEELUNG CITY (TW)

(21) Appl. No.: 15/062,286

(22) Filed: Mar. 7, 2016

(51) Int. Cl. F21S 8/10

(52) U.S. Cl. CPC F21S 48/1757; F21S 48/115; F21S 48/1388

(57) ABSTRACT

An adjustable headlight device comprises a lens having a light input portion and a light output portion, a light reflection control set having a first and a second light reflection members, and a light emitting diode arranged between the first and the second light reflection members. The first light reflection member is arranged under the lens and has a first reflection portion arranged toward the light input portion. The second light reflection member is arranged at one side of the light input portion and has a second reflection portion arranged toward the light input portion. the first light reflection member and the second light reflection member are configured to effectively decrease the light transmission space with the light reflection principle. The adjustable headlight device may make a lighting distance change to achieve the effect of switching a high beam headlight and a low beam headlight.

### BACKGROUND OF THE INVENTION

1. Field of the Invention

The present invention relates to an adjustable headlight device, and especially relates to an adjustable headlight device capable for having the functions of a high beam headlight and a low beam headlight and achieving the effect of space saving.

2. Description of Related Art

Recently, many people in Taiwan ride motorcycles for the consideration of convenience and mobility. Although the motorcycle is thought that it is convenient and mobile, it is a vehicle without safety. The danger for riding motorcycle may be increased due to low visibility in dark. Otherwise, although the safety of driving car is better than the one of riding motorcycle, the visibility may be also influenced by the headlight device. When the brightness of the headlight device is bad, the rider may be in danger if he/she is not concentrated or not familiar with the condition of the road. Furthermore, the identification is not enough so as to cause others in danger. Therefore, there are many headlight device with high brightness in the market which are increased the brightness while riding or driving so as to make himself/herself and others safe.

Please reference to Taiwanese patent no. 1400408, it disclosed an illumination apparatus is suitable for vehicle lamp using. The illumination apparatus includes a first reflective element, a second reflective element, a reflective substrate and a light source. The first reflective element has a reflective paraboloid and the second reflective element has a partial reflective ellipsoid. The reflective substrate includes a focal point of the paraboloid and a first focal point and a second focal point of the partial ellipsoid thereon wherein the focal point of the paraboloid substantially overlaps with the first focal point of the partial ellipsoid and is disposed on a line connecting the second focal point of the partial ellipsoid and a vertex of the paraboloid. The light source is positioned on the focal point of the paraboloid and suitable for providing a light beam. The extension of a line connecting the outer edge of the first reflective element and the outer edge of the second reflective element passes through the area between the light source and vertex of the paraboloid.

According to above mentioned, the conventional headlight device has some drawbacks which are described as follows.

Firstly, the light transmission of the headlight device is performed by reflecting or projecting so that the light transmission path is much longer and the whole headlight device needs much longer space.

Secondly, the conventional headlight device needs two light sources to perform the effect of switching high beam headlight and low beam headlight so that the costs of production and materials are increased.

In view of the foregoing circumstances, the inventor has invested a lot of time to study the relevant knowledge, compare the pros and cons, research and develop related products. After quite many experiments and tests, the “adjustable headlight device” of this invention is eventually launched to improve the foregoing shortcomings, to meet the public use.

### SUMMARY OF THE INVENTION

A main object of this invention is providing an adjustable headlight device which comprises a lens, a light refection control set, and a light emitting diode. The first light reflection member and the second light reflection member of the light reflection control set are configured to effectively decrease the light transmission distance and length, and additionally, the adjustable headlight device may make a lighting distance change to achieve the effect of switching a high beam headlight and a low beam headlight.

In order to achieve above mentioned object, an adjustable headlight device comprises a lens, having a light input portion and a light output portion, the light input portion has a plane surface and the light output portion has a curved ring surface or each of the light input portion and the light output portion has a curved ring surface, the curved ring surface is a cylindrical surface or a curved ring spherical surface or the curved ring surface is cylindrical aspherical surface or curved ring aspherical surface; a light reflection control set, including a first light reflection member and a second light reflection member, the first light reflection member is arranged under the lens, the first light reflection member has a first reflection portion arranged toward the light input portion, the second light reflection member is arranged at one side of the light input portion, the second light reflection member has a second reflection portion arranged toward the light input portion; and a light emitting diode, arranged between the first light reflection member and the second light reflection member, the light emitting diode is arranged adjacent to the first light reflection member, the light emitting diode is generated a light beam and clockwise rotated an angle θ; wherein the first light reflection member and the second light reflection member of the light reflection control set are configured to reduce a transmission distance of the light beam with light reflection principle and the adjustable headlight device is adjusted so that the angle of the light beam emitted from the light output portion is changed and a lighting distance of the adjustable headlight device is controlled.

In some embodiments, the adjustable headlight device further comprises a first focal point and a second focal point, the light emitting diode is arranged at the first focal point, the light beam is reflected from the first light reflection member to the second light reflection member and then focused on the second focal point, and the light beam reflected from the second light reflection member to the light input portion is a collimated light.

In some embodiments, the adjustable headlight device further comprises an adjustable angle φ which is angled between 0.6 and 1.5 degree.

In some embodiments, the lens is arranged at one side of the second reflection portion reflected the light beam, and a curvature radius of the lens in a horizontal direction is 320 mm.

In some embodiments, the first light reflection member is an elliptical surface member and the second light reflection member is a paraboloid member.

In some embodiments, the angle θ is angled between 10 and 20 degree and the light emitting diode is a white light emitting diode.

The various objects and advantages of the present invention will be more readily understood from the following detailed description when read in conjunction with the appended drawing.

### BRIEF DESCRIPTION OF THE DRAWINGS

FIG. 1 is a structural view of an adjustable headlight device of the present invention;

FIG. 2 is a structural view of the adjustable headlight device of the present invention which is used as a high beam headlight;

FIG. 3 is a structural view of the adjustable headlight device of the present invention which is used as a low beam headlight while rotating; and

FIG. 4 is a view of the adjustable headlight device of the present invention which is used as the high beam headlight and the low beam headlight.

### DETAILED DESCRIPTION OF THE INVENTION

To describe clearly that the present invention achieves the foregoing object and function, the technical features and desired function are described with reference to a preferred embodiment and accompanying drawings.

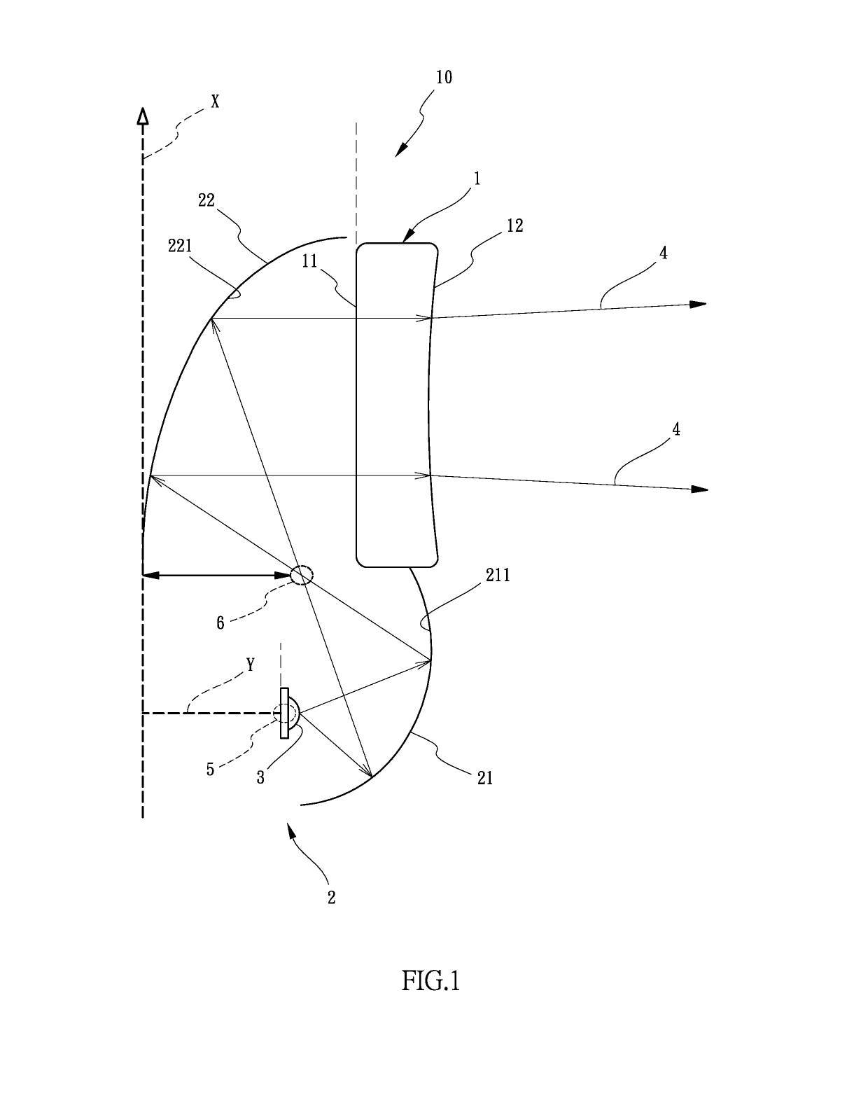

Please reference to FIGS. 1 to 3, an adjustable headlight device (in FIGS. 1 to 3, a first axis X and a second axis Y is assumed to imaging axes, a first axis X1 represents that the first axis X is rotated an angle φ(X2), a second axis Y1 represents that the second axis Y is rotated an angle φ(Y2)) of the present invention may comprise a lens 1, a light reflection control set 2, and a light emitting diode 3. The lens 1 has a light input portion 11 and a light output portion 12. The light input portion 11 has a plane surface and the light output portion 12 has a curved ring surface or each of the light input portion 11 and the light output portion 12 has a curved ring surface. The curved ring surface may be a cylindrical surface or a curved ring spherical surface or the curved ring surface may be cylindrical aspherical surface or curved ring aspherical surface. The light reflection control set 2 may include a first light reflection member 21 and a second light reflection member 22. The first light reflection member 21 is arranged under the lens 1. The first light reflection member 21 has a first reflection portion 211 arranged toward the light input portion 11. The second light reflection member 22 is arranged at one side of the light input portion 11. The second light reflection member 22 has a second reflection portion 221 arranged toward the light input portion 11. The light emitting diode 3 is arranged between the first light reflection member 21 and the second light reflection member 22. The light emitting diode 3 is arranged adjacent to the first light reflection member 21. The light emitting diode 3 is generated a light beam and clockwise rotated an angle θ (numbered as 31). Therefore, the first light reflection member 21 and the second light reflection member 22 of the light reflection control set 2 are configured to reduce a transmission distance of the light beam with light reflection principle and the light reflection control set 2 may be simplified to save space. Since the light emitting diode 3 is arranged adjacent to the first light reflection member 21, the light beam 4 emitting from the light emitting diode 3 is reflected from the first light reflection member 21 to the second light refection member 22 to improve the recyclability. The improvement of the recyclability is caused by the light emitting diode 3 rotated the angle θ (numbered as 31) so that the light beam 4 entered the first light reflection portion 211 may be increased and further the brightness of the adjustable headlight device 10 may be increased. The adjustment of the adjustable headlight device 10 may be performed by adjusting the angle of the light beam 4 emitting from the light output portion 12 (the manners may be performed in a mechanical way or used the prior art technical methods, but not limited thereto) and further a lighting distance of the adjustable headlight device 10 may be also controlled to adjust.

The above mentioned embodiment is the main skill feature of this invention and corresponds to the claim 1 of this invention to understand the object and embodiments of this invention in detail. And the skill features of the depending claims are for describing the claim 1 in detail or adding more skill features, but not limited thereto. It should be known that the claim 1 is not necessary to include the skill features of the depending claims.

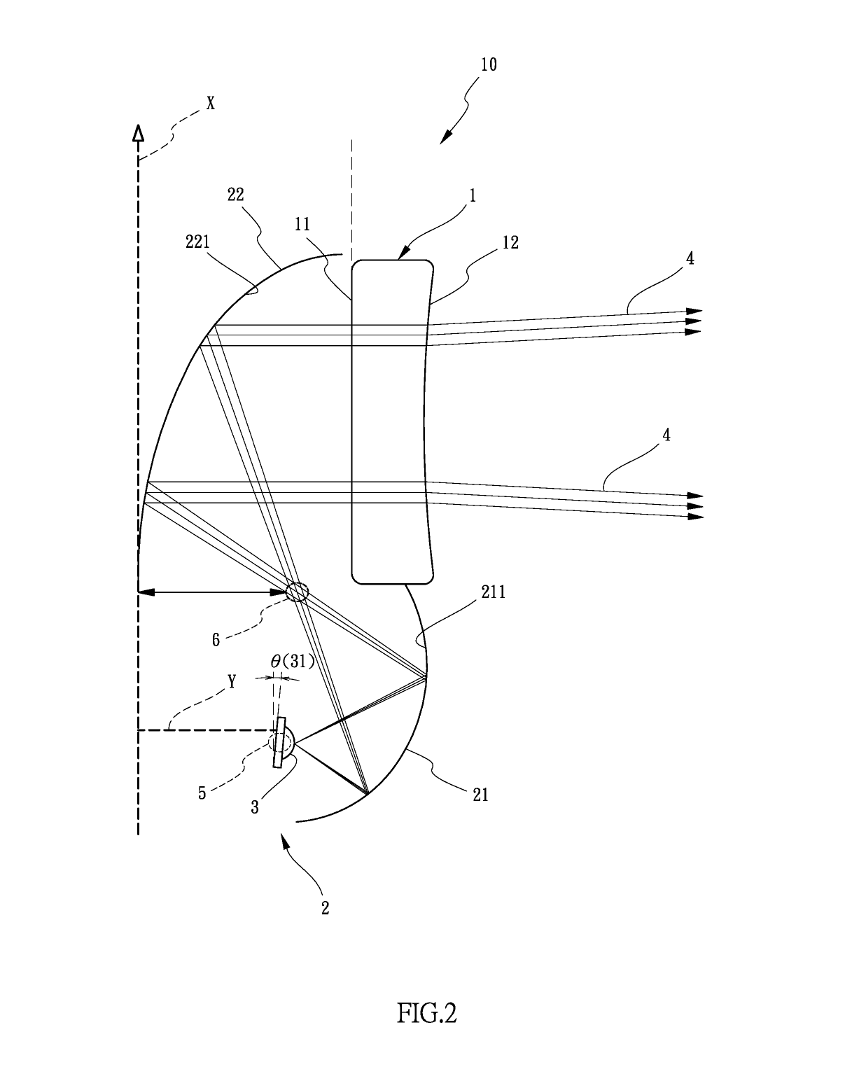

Please refer to FIGS. 1 and 2, the adjustable headlight device 10 may further comprise a first focal point 5 and a second focal point 6. The light emitting diode 3 is arranged at the first focal point 5. The light beam 4 is reflected from the first light reflection member 21 to the second light reflection member 22 and then focused on the second focal point 6. The light beam 4 reflected from the second light reflection member 22 to the light input portion 11 is a collimated light. The first focal point 5 is the focus of the first light reflection member 21 and the second focal point 6 is the focus of the second light reflection member 22. The arrangement of the light emitting diode 3, the first light reflection member 21, and the second light reflection member 22 may be optimized the transmission of the light beam 4. Because the light input portion 11 has the plane surface and the light beam 4 reflected from the second light reflection member 22 is the collimated light, the light received by the light input portion 11 is even and the illuminated effect of the light input portion 11 may keep consistent.

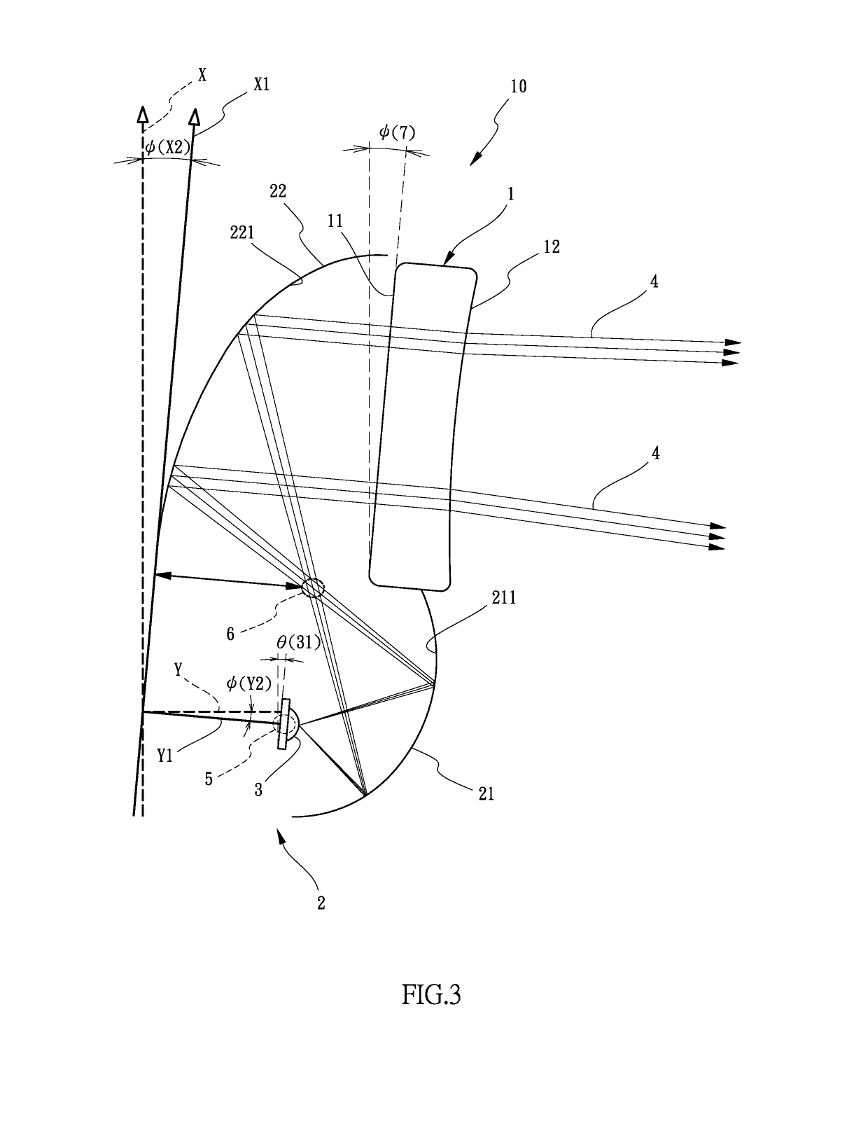

Please refer to FIG. 3, the adjustable headlight device 10 may further comprise an adjustable angle φ (numbered as 7) which is angled between 0.6 and 1.5 degree. The adjustable headlight device 10 may be clockwise adjusted. The angle φ (numbered as 7) is ranged for meeting the specification and adjusting based on the distance between the installation position and the ground which are not fixed.

Please refer to FIGS. 1 to 3, the lens 1 is arranged at one side of the second reflection portion 221 reflected the light beam and a curvature radius of the lens 1 in a horizontal direction is 320 mm. The light beam 4 emitted from the light output portion 12 is divergent.

Please refer to FIGS. 1 to 3, the first light reflection member 21 is an elliptical surface member and the second light reflection member 22 is a paraboloid member.

In addition, please refer to FIG. 2, the light emitting diode 3 may be clockwise rotated an angle θ (numbered as 31) and the angle θ is angled between 10 and 20 degree. The light emitting diode 3 is a white light emitting diode. The preferable angle θ (numbered as 31) 15.6 degree in the clockwise direction so as to mainly improve the recyclability of the light beam 4 emitted from the light emitting diode 3. The election of the white light emitting diode 3 is mainly for increasing the brightness of the adjustable headlight device 10 while driving in the environments of high speed, night, and poor visibility. The illuminance of the white light emitting diode 3 is 20 Lux to use as a light source (not shown).

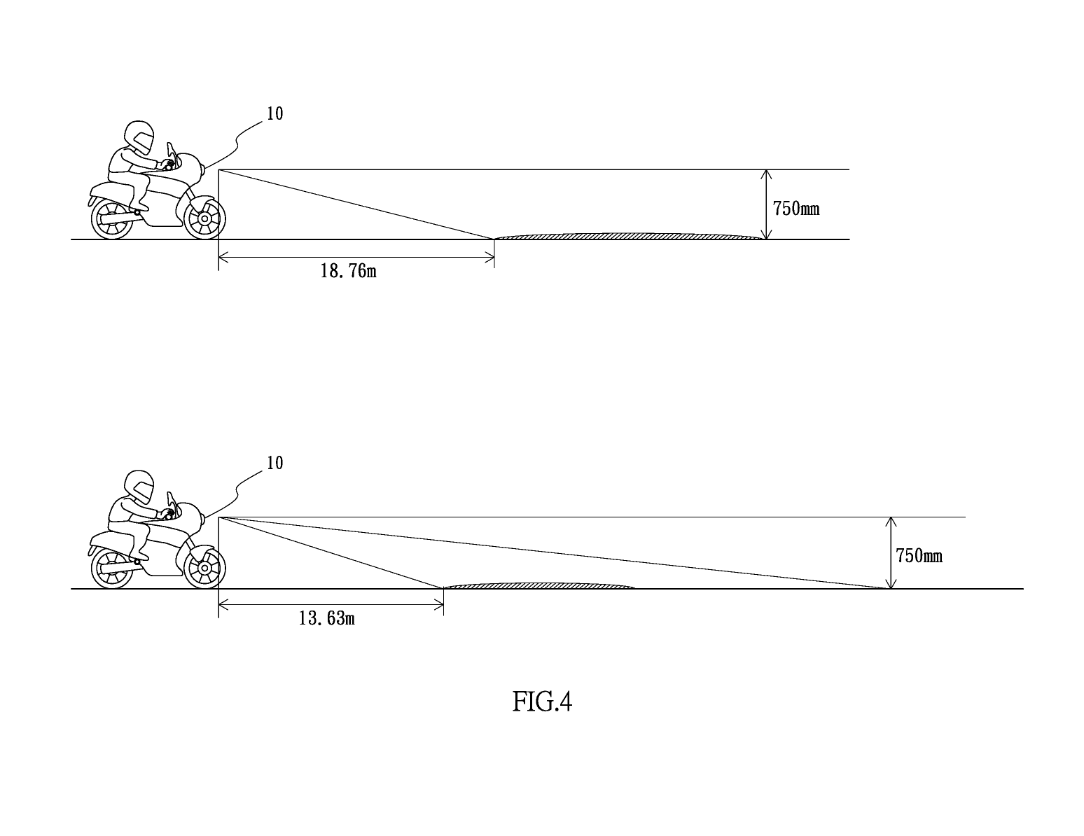

Please refer to FIGS. 2 to 4, a distance between a position which the adjustable headlight device 10 is installed at various bicycle frame and the ground is different so that the adjustable headlight device 10 may achieve the effect of rotating the adjustable angle φ (numbered as 7) and the distance relative to the ground may be suitably adjusted. The operation conditions may be assumed as follows. The light beam 4 emitted from the light emitting diode 3 of the adjustable headlight device 10 is reflected from the first reflection portion 211 of the first light reflection member 21 of the light reflection control set 2, passed through the focus of the second light reflection member 22 to the second light reflection member 22, and then reflected from the second reflection portion 221 of the second light reflection member 22 with the type of collimated light beam 4 to the lens. The light beam 4 after being transmitted by the light input portion 11 of the lens may be formed the evened lights and then transmitted by the light output portion 12 to become the divergent light beam 4 so as to achieve the effect of lighting to the ground. Please refer to FIG. 4, it is assumed that the adjustable headlight device 10 is installed at a position of a motorcycle and the distance between the position of the motorcycle and the ground is 750 mm. Under the condition of the angle φ (numbered as 7) which is not adjusted, the distance between the light output portion 12 and a position that the light beam 4 emitted from the light output portion 12 is firstly contacted with the ground is 18.76 m and it is a high beam headlight. When the lighting distance needs to be adjusted, the adjustable headlight device 10 may be clockwise rotated in an angle of 0.86 degree (it is not corrected because the distance 750 mm is set and the rotation angle is definitely defined in the claims to meet the positions of the high beam headlight and the low beam headlight), the distance between the light output portion 12 and a position that the light beam 4 emitted from the light output portion 12 is firstly contacted with the ground is 13.63 m and it becomes a low beam headlight.

In conclusion, there are some advantages for the adjustable headlight device 10 which are described as follows.

Firstly, the first light reflection member 21 and the second light reflection member 22 of the light reflection control set 2 are configured to effectively decrease the light transmission space with the light reflection principle.

Secondly, the adjustable headlight device 10 is adjusted so as to change the distance between the light output portion 12 and a position that the light beam 4 emitted from the light output portion 12 is firstly contacted with the ground. The adjustable headlight device 10 of the present invention needs only single one light emitting diode to achieve the effect of adjusting the light beam 4 to perform high beam and low beam.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

What is claimed is:

1. An adjustable headlight device, comprising:
a lens, having a light input portion and a light output portion, the light input portion has a plane surface and the light output portion has a curved ring surface or each of the light input portion and the light output portion has a curved ring surface, the curved ring surface is a cylindrical surface or a curved ring spherical surface or the curved ring surface is cylindrical aspherical surface or curved ring aspherical surface;
a light reflection control set, including a first light reflection member and a second light reflection member, the first light reflection member is arranged under the lens, the first light reflection member has a first reflection portion arranged toward the light input portion, the second light reflection member is arranged at one side of the light input portion, the second light reflection member has a second reflection portion arranged toward the light input portion; and
a light emitting diode, arranged between the first light reflection member and the second light reflection member, the light emitting diode is arranged adjacent to the first light reflection member, the light emitting diode is generated a light beam and clockwise rotated an angle θ;
wherein the first light reflection member and the second light reflection member of the light reflection control set are configured to reduce a transmission distance of the light beam with light reflection principle and the adjustable headlight device is adjusted so that the angle of the light beam emitted from the light output portion is changed and a lighting distance of the adjustable headlight device is controlled.

2. The adjustable headlight device as claimed in claim 1, further comprising a first focal point and a second focal point, the light emitting diode is arranged at the first focal point, the light beam is reflected from the first light reflection member to the second light reflection member and then focused on the second focal point, and the light beam reflected from the second light reflection member to the light input portion is a collimated light.

3. The adjustable headlight device as claimed in claim 2, further comprising an adjustable angle φ which is angled between 0.6 and 1.5 degree.

4. The adjustable headlight device as claimed in claim 3, wherein the lens is arranged at one side of the second reflection portion reflected the light beam, and a curvature radius of the lens in a horizontal direction is 320 mm.

5. The adjustable headlight device as claimed in claim 1, wherein the first light reflection member is an elliptical surface member and the second light reflection member is a paraboloid member.

6. The adjustable headlight device as claimed in claim 1, wherein the angle θ is angled between 10 and 20 degree and the light emitting diode is a white light emitting diode.
